(19) United States
(12) Patent Application Publication
(10) Pub. No.: US 2026/0145285 A1
(43) Pub. Date: May 28, 2026

(54) FIXTURE AND METHOD OF USING THE SAME

(71) Applicants: CHAMP TECH OPTICAL (FOSHAN) CORPORATION, Foshan (CN); Foxconn Technology Co., Ltd., New Taipei (TW)

(72) Inventors: CHUN-CHI CHEN, New Taipei (TW); TAO LI, Foshan (CN); JING-YUAN LIU, Foshan (CN)

(21) Appl. No.: 19/081,144

(22) Filed: Mar. 17, 2025

(30) Foreign Application Priority Data
Nov. 28, 2024 (CN) 202411735063.1

(51) Int. Cl. B23Q 3/18

(52) U.S. Cl. CPC B23Q 3/18; F28F 2240/00; F28F 2255/00

(57) ABSTRACT

A fixture for supporting a plurality of workpieces to be processed that are arranged at intervals, the fixture includes a base and a plurality of supporting members. The plurality of supporting members is provided on one side of the base, a limiting space is defined between every two adjacent supporting members, the limiting space is configured to accommodate each of the plurality of workpieces to be processed.

### FIELD

The subject matter herein generally relates to the field of heat sinks, and in particular, to a fixture and a method of using the fixture.

### BACKGROUND

A heat sink of a server may include a base and a plurality of heat dissipation fins welded onto the base. In the process of welding the heat dissipation fins to the base, a large amount of pressure is required to improve the welding strength.

However, the heat dissipation fin has a large height but a small thickness, such that the heat dissipation fins are easily deformed under the pressure. Such deformation not only affects the appearance of the heat sinks, but also destroys the internal airflow channel structure, which blocks the air flow and reduces heat dissipation efficiency. Thus, the performance, reliability, and service life of the server are affected.

### BRIEF DESCRIPTION OF THE DRAWINGS

Implementations of the present technology will now be described, by way of example only, with reference to the attached figures.

FIG. 1 is a schematic view of a fixture according to an embodiment of the present application.

FIG. 2 is a schematic view of the fixture shown in FIG. 1, when viewed from another angle.

FIG. 3 is a schematic view of the fixture shown in FIG. 1 and a heat sink.

FIG. 4 is a schematic view showing the fixture in use.

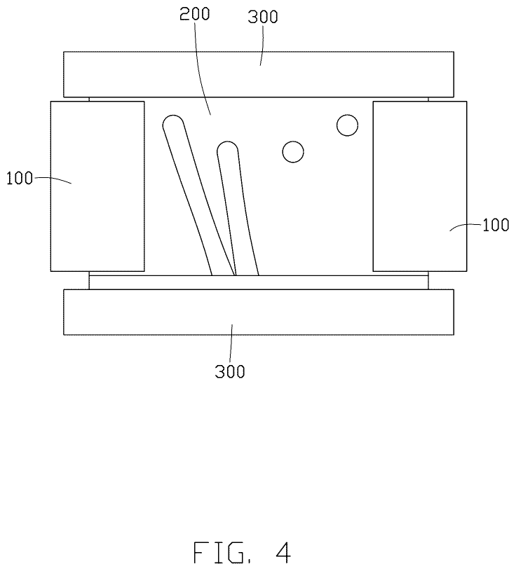

FIG. 5 is a flowchart of a method of using the fixture according to an embodiment of the present application.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

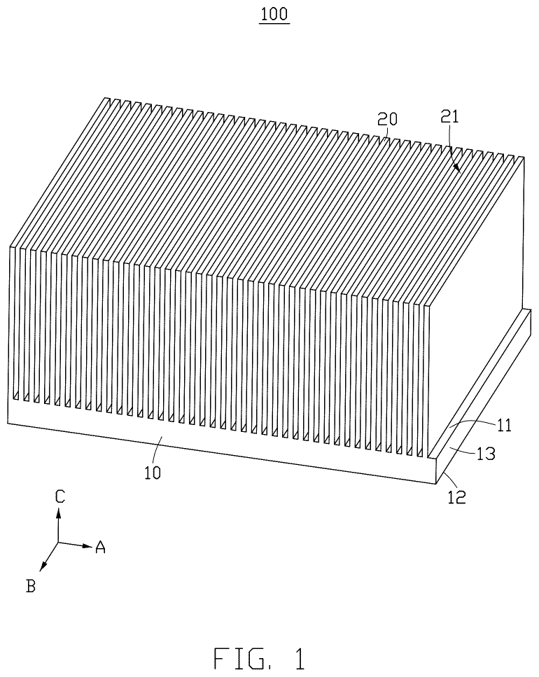

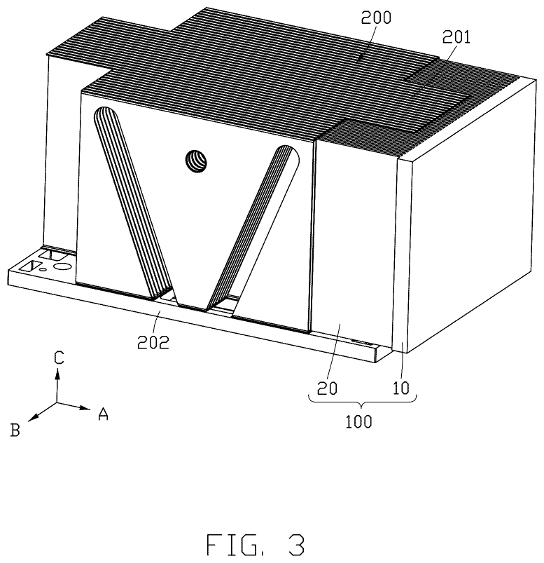

Referring to FIG. 1 and FIG. 3, a fixture 100 is provided according to an embodiment of the present application. The fixture 100 is applied to support heat dissipation fins 201, so that the heat dissipation fins 201 are welded to a heat dissipation base 202 to form a heat sink 200.

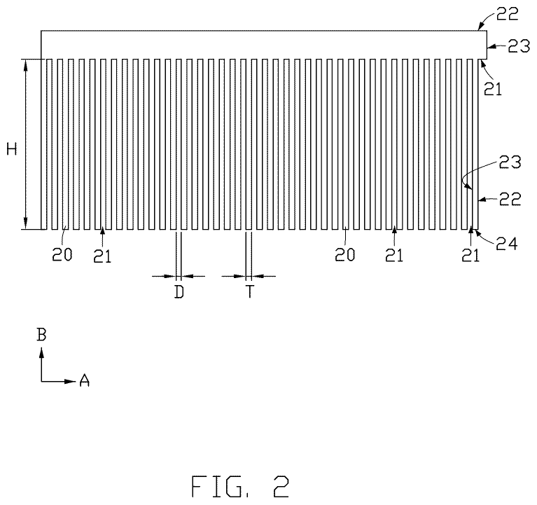

Referring to FIG. 1 and FIG. 2, the fixture 100 includes a base 10 and a plurality of supporting members 20. The supporting members 20 are comb-shaped and connected to one side of the base 10. A limiting space 21 is defined between two adjacent supporting members 20, and the limiting space 21 is in communication with the external environment. The limiting space 21 is used for accommodating a workpiece to be processed. In other embodiments, the supporting members 20 may be movably disposed on one or more sides of the base 10, thereby defining the limiting spaces 21 of various shapes and sizes to adapt to different workpieces to be processed.

When the fixture 100 is in use, the heat dissipation fins 201 are first aligned with the heat dissipation base 202, with a gap being formed between two adjacent heat dissipation fins 201. The width of each gap needs to be controlled within a specific range, for example, in a range from 5 millimeters to 8 millimeters. Then, the supporting members 20 of the fixture 100 are inserted from a side of the fixture 100 into the gaps of the heat dissipation fins 201. Specifically, referring to FIG. 3, once the heat dissipation fins 201 have been properly aligned with the heat dissipation base 202, the supporting members 20 are inserted from a lateral side (e.g., left or right) of the fixture 100 in a direction generally perpendicular to the arrangement of the heat dissipation fins 201. This approach ensures that each supporting member 20 can enter the gap between adjacent heat dissipation fins 201 without interference from the heat dissipation base 202 or the fixture 100. Thus, the heat dissipation fins 201 are inserted into the limiting spaces 21 one by one. In this way, the heat dissipation fins 201 form a stable arrangement, thereby improving the stability during the welding of the heat dissipation fins 201 to the heat dissipation base 202 and reducing the bending of the heat dissipation fins 201.

In the present embodiment, the width of the gap between two adjacent heat dissipation fins 201 is defined as M, and correspondingly, the distance between two adjacent supporting members 20 is defined as D, wherein 0.5 mm<D<0.75M. For example, when M is 5 millimeters, D may be 2.5 to 3.75 millimeters; when M is 8 millimeters, D may be 4 to 6 millimeters. The above relationship allows the supporting members 20 to be smoothly inserted into the gap while achieving close contact between the heat dissipation fins 201 and the supporting member 20.

In the present embodiment, the base 10 is substantially cuboid and has a length direction A, a width direction B, and a thickness direction C. Two of the above three directions are perpendicular to each other. The base 10 includes a first surface 11, a second surface 12, and a plurality of first connecting surfaces 13. Along the thickness direction C, the first surface 11 and the second surface 12 are opposite to each other with a space therebetween. The first connecting surface 13 is connected between the first surface 11 and the second surface 12. The supporting members 20 are arranged side by side on the first surface 11, and two adjacent supporting members 20 are arranged in parallel at intervals.

In the present embodiment, the supporting members 20 are arranged side by side along the length direction A, and the supporting members 20 extend away from the base 10 along the width direction B and the thickness direction C. Thus, the heat dissipation fins 201 are supported and positioned without substantially increasing the volume of the fixture 100. Along the thickness direction C, the projection of the supporting members 20 are within the base 10. Thus, the compactness and stability of the overall structure of the fixture 100 are improved, while also reducing the shaking of the supporting members 20 during use.

In the present embodiment, along the length direction A, the distance D between two adjacent supporting members 20 is in a range from 5 millimeters to 8 millimeters so as to ensure that the heat dissipation fins 201 can be smoothly inserted between two adjacent supporting members 20. Each supporting member 20 has a thickness T of 0.1 millimeters to 0.5 millimeters so as to provide sufficient support for the heat dissipation fins 201 without exerting excessive pressure on the heat dissipation fins 201. Along the thickness direction C, the height H of each supporting member 20 is greater than 3 millimeters, thereby allowing the supporting member 20 to cover the entire heat dissipation fin 201 during installation and providing support.

In the present embodiment, each supporting member 20 is substantially plate-shaped, and includes a third surface 22, a fourth surface 23, and a second connecting surfaces 24. The third surface 22 and the fourth surface 23 are opposite to each other with a space therebetween, and the second connecting surfaces 24 are connected between the third surface 22 and the fourth surface 23. Each of the second connecting surface 24 includes a curved surface. The curved surface better distributes the pressure when being in contact with the heat dissipation fins 201, thereby reducing the damage to the heat dissipation fins 201 and facilitating a smoother insertion of the supporting members 20 into the gap.

In the present embodiment, the base 10 includes a high-strength aluminum alloy, which provides the advantages of light weight, high strength, and good thermal conductivity. Such material only ensures the overall strength of the fixture 100, but also improves heat dissipation efficiency.

The supporting members 20 includes an engineering plastic such as polyoxymethylene (POM), which includes good wear resistance, self-lubricating properties, and a certain degree of elasticity. These properties provide cushioning function when the supporting members 20 are in contact with the heat dissipation fins 201, thereby further reducing the damage to the heat dissipation fins 201. Meanwhile, the stable physical properties of this material ensure reliable support during the welding process.

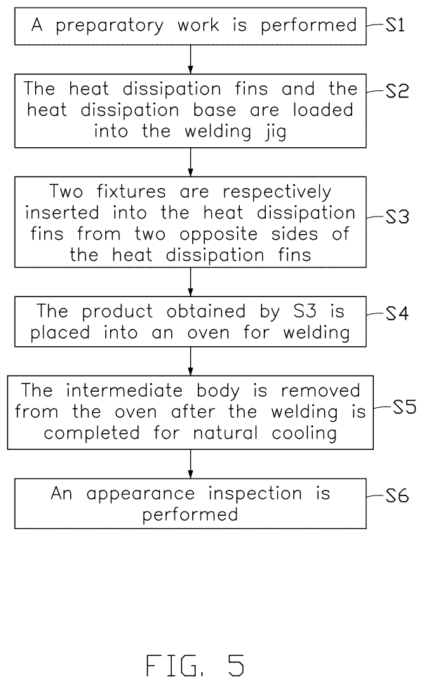

Referring to FIG. 5, a method of using the fixture 100 is provided according to an embodiment of the present application, and the method comprises the following steps:
S1: a preparatory work is performed. For example, the preparatory work includes checking the appearance or dimension of the fixture 100 and a welding jig 300. The preparatory work further includes cleaning the fixture 100, the heat dissipation fins 201, and the heat dissipation base 202 to remove dust, grease, and other impurities on the surface, so as to ensure welding quality.
S2: the heat dissipation fins 201 and the heat dissipation base 202 are loaded into the welding jig 300, while ensuring an accurate alignment of the heat dissipation fins 201 and the heat dissipation base 202. Then, the heat dissipation fins 201 and the heat dissipation base 202 are fixed in the welding jig 300, thereby preventing any movement or tilting during the subsequent welding process.
S3: two fixtures 100 are respectively inserted into the heat dissipation fins 201 from two opposite sides of the heat dissipation fins 201, so that the supporting members 20 of the fixture 100 fits tightly against the side surfaces of the heat dissipation fins 201. That is, each of the heat dissipation fins 201 is received in the limiting space 21 between two adjacent supporting members 20. Then, the position of the supporting members 20 of the tooling fixture 100 may be adjusted to allow the supporting members 20 to be precisely aligned with the heat dissipation fins 201, thereby providing uniform lateral support and preventing the heat dissipation fins 201 from shifting or deforming during the subsequent welding process.
S4: the product obtained by S3 is placed into an oven for welding. The above product includes the base 202 and the dissipation fins 201 to be welded, along with the fixture 100 and the welding jig 300. The welding is carried out according to predetermined welding parameters (e.g., temperature, time duration, pressure, etc.), thereby forming an intermediate body. The temperature, pressure, and other parameters are monitored in real time during the welding process to ensure stable and reliable welding quality.
S5: the intermediate body is removed from the oven after the welding is completed for natural cooling, so as to avoid material stress changes caused by a sudden drop in temperature. After the intermediate body has cooled to a desired temperature, the fixtures 100 on both sides of the intermediate body are carefully removed to prevent any damage to the heat dissipation fins 201. Finally, the intermediate body is taken out of the welding jig 300 to form the heat sink 200, and the entire welding procedure is completed.
S6: an appearance inspection is performed, for example, the arrangement of the heat dissipation fins 201 is checked, and whether there is bending, deformation, or damages are also checked, so as to ensure that the appearance quality of the heat sink 200 meets the requirements. The welding quality is also checked, for example, the welded area on the heat sink 200 is checked to ensure a secure welding without false welding, cold soldering, or welding defects. A functional test is also performed according to the preset requirements of the heat sink 200, thereby ensuring that the heat dissipation effect and mechanical strength of the heat sink 200 can meet the design specifications.

The fixture 100 provided in the present application has the following advantages. For example, the fixture 100 can be quickly and easily installed to and removed from the heat sink 200 as needed, which greatly reduces the overall processing time and labor costs while maintaining reliable support for the heat dissipation fins 201. The “comb-tooth” structure formed by the supporting members 20 can simultaneously support multiple heat dissipation fins 201, thereby providing uniform lateral support and preventing the heat dissipation fins 201 from bending or deforming during the welding process. The fixture 100 reduces direct contact between the adjacent heat dissipation fins 201, thereby reducing the damages such as scratches to the heat dissipation fins 201. By adjusting the spacing and thickness of the supporting members 20, the fixture 100 is adaptable to the heat dissipation fins 201 of different specifications, thus providing good versatility.

In other embodiments of the present application, the fixture 100 may be applied to a variety of other workpieces to be processed that have similar structural requirements.

For example, during the electronic components are welded onto circuit boards, numerous tiny pins of the electronic component must remain in a stable position to ensure accuracy and reliability of the welding operation. Because these pins are densely arranged and prone to deformation when heated, the fixture 100 can be inserted into the gaps between adjacent pins, preventing displacement or deformation of the pins under high welding temperature or external force.

Furthermore, during the machining of precision components such as micro-springs or metal foil sensors, the fixture 100 can be placed between adjacent foil pieces to ensure the neat arrangement and stable machining of the foil pieces, thereby avoiding deformation caused by thermal or mechanical stress.

Moreover, in fields such as aerospace or automobile manufacturing, small-sized composite material boards often require precise positioning during bonding or assembly process. The fixture 100 can provide the positioning function, preventing shape or structural damage caused by mutual squeezing or uneven force.

Moreover, in the installation process of various optical components such as gratings or optical filters, the fixture 100 can be used to support and position the optical components, ensuring the flatness and spacing accuracy of optical components.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A fixture to support a plurality of workpieces arranged at intervals, the fixture comprising:
a base; and
a plurality of supporting members,
wherein the plurality of supporting members is connected to one side of the base and arranged at intervals, each two adjacent of the plurality of supporting members cooperatively define a limiting space, and the limiting space is configured to accommodate a corresponding one of the plurality of workpieces therein.

2. The fixture according to claim 1, wherein the base comprises a first surface, a second surface, and a plurality of first connecting surfaces, the first surface and the second surface are opposite to each other, and the plurality of first connecting surfaces is connected between the first surface and the second surface and arranged at intervals on the first surface.

3. The fixture according to claim 1, wherein the base defines a length direction and a thickness direction, the plurality of supporting members are arranged at intervals along the length direction, and the plurality of supporting members extend away from the base along the thickness direction.

4. The fixture according to claim 3, wherein a projection of the plurality of supporting members along the thickness direction is within the base.

5. The fixture according to claim 1, wherein each of the plurality of supporting member has a thickness of 0.1 millimeters to 0.5 millimeters and a height of more than 3 millimeters.

6. The fixture according to claim 1, wherein each of the plurality of supporting member comprises a third surface, a fourth surface, and a plurality of second connecting surfaces, the third surface and the fourth surface are opposite to each other, the plurality of second connecting surfaces is connected between the third surface and the fourth surface, and each of the plurality of second connecting surfaces comprises a curved surface.

7. The fixture according to claim 1, wherein the base is made of an aluminum alloy or stainless steel, and the plurality of supporting members is made of polyoxymethylene.

8. The fixture according to claim 1, wherein the base is cuboid.

9. The fixture according to claim 1, wherein the base and the plurality of supporting members are integrally formed.

10. The fixture according to claim 1, wherein the limiting space is opened at two opposite sides of the plurality of supporting members.

11. A method of using the fixture according to claim 1, the method comprising:
inserting the plurality of workpieces into the fixture, wherein each of the plurality of workpieces is receiving in the limiting space between two adjacent of the plurality of supporting members;
welding the plurality of workpieces to a base to obtain a product; and
removing the fixture from the product.

12. The method according to claim 11, wherein a width of a gap between two adjacent of the plurality of workpieces is defined as M, a distance between two adjacent of the plurality of supporting members is defined as D, 0.5 mm<D<0.75M.

13. The method according to claim 11, wherein before removing the fixture from the product, the method further comprises:
cooling the plurality of workpieces after welded to a room temperature.

14. The method according to claim 11, wherein the welding comprises:
applying a predetermined temperature and pressure on the plurality of workpieces or the base according to at least one of a thickness and a height of the plurality of workpieces.

15. The method according to claim 8, wherein the plurality of workpieces is a plurality of heat dissipation fins, which is welded to the base to form a heat sink, and each of the plurality of heat dissipation fins has a thickness of 0.3 millimeters and a height of more than 64 millimeters.
